(19) United States
(12) Patent Application Publication
(10) Pub. No.: US 2002/0112499 A1
(43) Pub. Date: Aug. 22, 2002

(54) Evaporative cooling article

(76) Inventor: Andy A. Goldfine, Duluth, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/004,262

(22) Filed: Oct. 31, 2001

Related U.S. Application Data
(63) Continuation-in-part of application No. 09/744,036, filed on Jan. 17, 2001.
(60) Provisional application No. 60/146,009, filed on Jul. 28, 1999.

(30) Foreign Application Priority Data
Jul. 26, 2000 (US) PCT/US00/20281

(51) Int. Cl. B32B 5/26; F28D 5/00; D04H 1/00; D04H 3/00; D04H 5/00; D04H 13/00; F17C 13/00; F25B 21/00

(52) U.S. Cl. 62/316; 442/414; 442/328; 62/304; 62/457.9

(57) ABSTRACT

An evaporative cooling article, the evaporative cooling article including a non-woven fabric, the non-woven fabric being water absorbent and exposed to atmosphere, the evaporative cooling article effective for exerting an evaporative cooling effect on a liquid held within a container when the container is in contact with the evaporative cooling article.

### CROSS-REFERENCE TO RELATED APPLICATION(S)

This United States Patent Application claims priority from and is a Continuation-In-Part Application of, U.S. patent application Ser. No. 09/744,036 entitled EVAPORATIVE COOLING FABRIC that was filed on Jan. 17, 2001. U.S. patent application Ser. No. 09/744,036 in turn claims priority from, and was filed under 35 U.S.C. §371 based upon, International Application No. PCT/US00/20281 that was filed on Jul. 26, 2000. International Application No. PCT/US00/20281 in turn claims priority from U.S. Provisional Patent Application Serial No. 60/146,009 that was filed on Jul. 28, 1999.

### BACKGROUND OF THE INVENTION

The present invention generally relates to evaporative cooling fabrics and evaporative cooling articles. More specifically, the present invention relates to evaporative cooling fabrics and evaporative cooling articles that are highly absorbent to water, wind-resistant, and able to exert a cooling effect by virtue of evaporation of absorbed water. The present invention also relates to methods of making evaporative cooling fabrics and evaporative cooling articles, to a method of cooling a body surface using the evaporative cooling fabrics, and to a methods of cooling an object and cooling fluids held in a container using the evaporative cooling articles.

The human body is comfortable within a relatively narrow range of temperatures. Under some circumstances, the human body is able to maintain a temperature within this comfort range by generation of sweat and subsequent evaporation of the sweat. However, under higher exertion levels and/or warmer temperatures, especially where humidity levels are elevated, the human body is not always able to sustain a sufficient level of cooling by this sweat generation/sweat evaporation mechanism. Consequently, for centuries, human beings have relied upon a number of different mechanisms for providing enhanced cooling of the human body beyond that provided by the sweat generation/sweat evaporation mechanism.

For example, woven cotton fabric has been formed into articles, such as bandanas, that are designed for placement against the skin. Under some circumstances, people have relied upon the cotton fabric to absorb sweat and the sweat is thereafter allowed to evaporate from the cotton fabric. However, water generated from sweat alone is often incapable of providing a comfortable level of cooling. Therefore, some people have saturated the cotton fabric with added water other than sweat. Wind blowing across the surface of the wet cotton converts the absorbed liquid water into water vapor that is released from the cotton fabric. The remaining liquid water is cooled due to the endothermic transformation of liquid water to water vapor.

Thus, cotton fabric that has been wetted with water has been used as an evaporative cooling fabric. However, such use of cotton fabric alone is not entirely satisfactory. First, since the cotton fabric is not covered with any other material and is therefore fully exposed to air currents, there is no control on the rate of water evaporation; therefore, there is no control on the rate of cooling provided by evaporation of water from the cotton fabric. This lack of control raises a couple of problems. First, an excessive amount of cooling may occur under some circumstances when using cotton fabric alone. Also, the lack of control causes the evaporative cooling capacity of the cotton fabric to be exhausted, relatively quickly, upon complete evaporation of all absorbed water.

Besides these problems relating to control of the evaporative cooling, cotton fabric, standing alone, suffers from other problems. First, cotton is prone to shrinkage. Thus, after laundering, an evaporative cooling garment made of cotton only may not continue to fit the user. Also, cotton loses its resiliency after repeated stretching. Resiliency is defined as the ability of a material to spring back to shape after being distorted. Thus, cotton fabric, when used alone as a cooling fabric, tends to deteriorate in appearance as repeated stretching occurs during use of the cotton fabric for evaporative cooling purposes. Finally, cotton has a relatively low reservoiring capacity for water. Typically, cotton fabric is only able to absorb up to about 2½ times its weight in water. This relatively low absorptive capacity, combined with the relatively high rate of water evaporation from cotton fabric, further prevents cotton fabric from providing a relatively long period of sustained cooling to the user.

As an alternative to cotton, rayon fabric may be used as an evaporative cooling material. Rayon is based upon manmade fibers derived from regenerated cellulose. Some rayon fabrics have much higher water absorption capabilities than cotton. Thus, these rayon fabrics support a longer period of evaporative cooling. However, use of rayon fabric alone as an evaporative cooling fabric still suffers from at least one of the problems encountered with use of cotton fabric alone. Specifically, there is no control on the rate or duration of evaporative cooling since there is no control on the rate of water evaporation from the rayon fabric. Besides this rate control problem, rayon fabric, standing alone, is unsatisfactory because of wear problems. Specifically, the tensile strength of rayon fabric drops by as much as about 50 percent when the rayon fabric is wet. Therefore, rayon fabric, when used alone, as an evaporative cooling material tends to stretch, break, and otherwise deteriorate in physical properties over repetitive cycles of use.

Some alternatives to use of a single fabric alone as an evaporative cooling material have been developed. For example, some manufacturers have incorporated loose, hydrophillic polymer crystals in fabric enclosures for use as an evaporative cooling material. The hydrophillic crystals both absorb water and, upon exposure to heat and/or wind currents, desorb water by evaporation. Also, due to the bonding of water within the crystal, the crystals help to decelerate the rate of water evaporation, and therefore extend the available evaporative cooling period. Nonetheless, the public has not been quick to accept evaporative cooling materials that incorporate these hydrophillic crystals. Some possible reasons why hydrophillic crystals are not favored include the expense of evaporative cooling materials that incorporate hydrophillic crystals and physical limitations of such evaporative cooling materials. For example, the need to entrap the crystals in a fabric envelope complicates and raises the cost of manufacturing evaporative cooling materials. Also, since the hydrophillic crystals are typically converted to a gel upon absorption of water, users must deal with a three-dimensional object that is relatively bulky and somewhat resistant to enveloping curved portions of human bodies, such as the head or neck of the human body where evaporative cooling is frequently most desired.

Despite the availability of several different types of evaporative cooling materials, a need remains for an improved evaporative cooling material. Some problems to be solved, as described above, include provision of a control mechanism for controlling the rate of evaporation of water from the evaporative cooling material. Also, the absorptive capacity of the evaporative cooling material should be enhanced to minimize the dry weight of the evaporative cooling material while also helping to lengthen the available evaporative cooling period. Also, resolution of wear and tear issues must be addressed to allow long term repetitive use of the evaporative cooling material by users. Finally, comfort issues must be addressed since users frequently discontinue use of materials solely because the materials are uncomfortable. Surprisingly, the evaporative cooling fabric of the present invention provides an excellent solution to each of the difficulties described above.

### BRIEF SUMMARY OF THE INVENTION

The present invention includes an evaporative cooling article. The evaporative cooling article includes a non-woven fabric that is water absorbent and exposed to atmosphere. The evaporative cooling article is effective for exerting an evaporative cooling effect on a liquid held within a container when the container is in contact with the evaporative cooling article. The present invention further includes an evaporative cooling system, a method of making an evaporative cooling article, and a method of making an evaporative cooling system.

### BRIEF DESCRIPTION OF THE DRAWINGS

FIG. 1 is a cross-sectional view of an evaporative cooling fabric of the present invention.

FIG. 2 is a cross-sectional view of a synthetic fiber that may be incorporated in the evaporative cooling fabric of the present invention.

FIG. 3 is a top plan view of the evaporative cooling fabric depicted in FIG. 1.

FIG. 4 is a cross-sectional view of another evaporative cooling fabric that may be formed in accordance with the present invention.

FIG. 5 is a top plan view of an evaporative cooling article formed from the evaporative cooling fabric of the present invention.

FIG. 6 is an isometric view illustrating a use of the evaporative cooling article depicted in FIG. 5.

FIG. 7 is an isometric view of an evaporative cooling system of the present invention.

FIG. 8 is another perspective view of the evaporative cooling system depicted in FIG. 7.

FIG. 9 is a perspective view of another evaporative cooling system of the present invention.

### DETAILED DESCRIPTION

The present invention generally relates to evaporative cooling fabrics and evaporative cooling articles. More specifically, the present invention relates to evaporative cooling fabrics and evaporative cooling articles that are highly absorbent to water, wind-resistant, and able to exert a cooling effect by virtue of evaporation of absorbed water. The present invention also relates to methods of making evaporative cooling fabrics and evaporative cooling articles, to a method of cooling a body surface using the evaporative cooling fabrics, and to a methods of cooling an object and cooling fluids held in a container using the evaporative cooling articles.

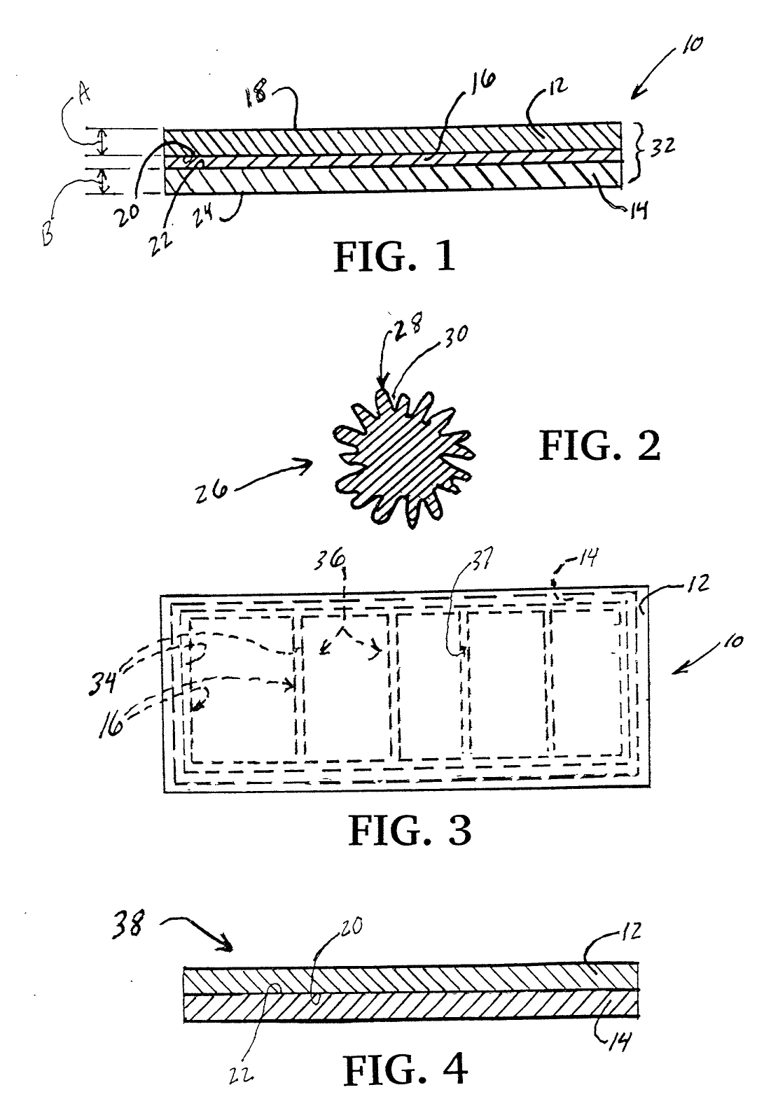

One form of the evaporative cooling fabric of the present invention is generally depicted at 10 in FIG. 1. The evaporative cooling fabric 10 includes a inner or face fabric layer 12, an outer or backing fabric layer 14, and an adhesive layer 16 that is sandwiched between the face fabric layer 12 and the backing fabric layer 14. The face fabric layer 12 has a pair of major surfaces 18, 20, and the backing fabric layer 14 has a pair of major surfaces 22, 24. In use, the surface 18 of the face fabric layer 12 is positioned against the body (skin) of a user (not shown). Non-exhaustive examples of users of the evaporative cooling fabric 10 include any mammal, including such non-exhaustive examples of mammals as a human being, a dog, a cow, a horse, or an elephant. The surface 24 of the backing fabric layer 14 faces away from the body of the user and is exposed to atmosphere, and the backing fabric layer 14 is separated from the body of the user by both the face fabric layer 12 and the adhesive layer 16.

The face fabric layer 12 is superabsorbent and consequently absorbs many times the weight of the face fabric layer 12 in water. The backing fabric layer 14 maybe formed of low porosity, woven material that is preferably wind-resistant. Since the backing fabric layer 14 is preferably wind-resistant, rather than wind proof, some air flow is preferably able to pass in and through the backing fabric layer 14. This wind flow triggers the vaporization and consequent evaporation of water from the face fabric layer 12. Due to the endothermic nature of water vaporization, the temperature of the face fabric layer 12 and the temperature of water held within the face fabric layer 12 are cooled, and the face fabric layer 12 consequently exerts a cooling effect on the body of the user. Furthermore, due to the preferred wind-resistant nature of the backing fabric layer 14, the backing fabric layer 14 preferably acts as a control on the rate of evaporation of water from the face fabric layer 12. This control effect of the backing fabric layer 14 combined with the superabsorbency of the face fabric layer 12, provides the evaporative cooling fabric 10 with an extended period of evaporative cooling effect on the body of the user.

The face fabric layer 12 may be a non-woven fabric. As used herein, a “non-woven fabric” is a textile structure that is produced by bonding of fibers, interlocking of fibers, or both bonding of fibers and interlocking of fibers that is accomplished by mechanical, chemical, thermal, or solvent mechanisms or any combination of these mechanisms. Contrasting, a “woven fabric,” as used herein, is a fabric that is produced when at least two sets of fibers or strands are interlaced, usually but not necessarily, at right angles to each other, according to a predetermined pattern of interlacing. In woven fabrics, at least one set of fibers or strands is oriented parallel to a longitudinal axis along the longest dimension of the fabric. A non-woven fabric does not include any fibers or strands that are interlaced according to a predetermined pattern of interlacing. The face fabric layer 12 is preferably formed as non-woven fabric to help enhance and maximize the water absorbency of the face fabric layer 12.

The non-woven nature of the face fabric layer 12 helps enhance the porosity of the face fabric layer 12, which in turn helps enhance the water-holding capacity of the face fabric layer 12. The high water-holding capacity of the face fabric layer 12 permits the face fabric layer 12 to serve as a water reservoir. The face fabric layer 12 is formed of a plurality of fibers (not shown), which, as explained above, may form non-woven fabric. The water that is held within the face fabric layer 12 is predominantly held on (adsorbed) and between the different fibers within the matrix of fibers that form the face fabric layer 12, though some of the retained water may also, and preferably is, absorbed into and held within the individual fibers that make up the face fabric layer 12.

The water sorption capacity of the face fabric layer 12 refers to the collective ability of the face fabric layer 12 to absorb liquid water within the fibers of the face fabric layer 12, to adsorb liquid water on the fibers of the face fabric layer 12, and otherwise accumulate water between different fibers of the face fabric layer 12. The water sorption capacity of the face fabric layer 12, expressed on the basis of the weight of water incorporated into the face fabric layer 12 per gram of dry weight of the face fabric layer 12, may be determined in accordance with ASTM Standard No. D5802-95, that is entitled Standard Test Method for Sorption of Bibulous Paper Products (Sorptive Rate and Capacity Using Gravimetric Procedures). A copy of ASTM Standard No. D5802-95 may be obtained from the American Society for Testing and Materials of West Conshohocken, Pa. The face fabric layer 12 should generally have a sorption capacity of at least about 20 grams of liquid water per gram of dry weight of the face fabric layer 12, as determined by ASTM Standard No. D5802-95, to enable quick filling of the face fabric layer 12 with water. Still more preferably, as determined by ASTM Standard No. D5802-95, the face fabric layer 12 should have a sorption capacity of at least about 24 grams of liquid water per gram of the face fabric layer 12 to enable even quicker filling of the face fabric layer 12 with water.

The water retention capacity of a particular fabric, expressed on the basis of the weight of retained water per dry weight of the fabric, may be determined in accordance with ASTM Standard No. D4250-92 (1999), that is entitled Standard Test Method for Water-holding Capacity of Bibulous Fibrous Products. A copy of ASTM Standard No. D4250-92 (1999) may be obtained from the American Society for Testing and Materials of West Conshohocken, Pa. The water retention capacity of the face fabric layer 12 is a measure of the hydrophillicity of fibers incorporated in the face fabric layer 12. As explained below, the fibers of the face fabric layer 12 are preferably hydrophillic to enhance the comfort of people using the evaporative cooling fabric 10. To provide the face fabric layer 12 with an adequate level of hydrophillicity, the face fabric layer 12 should be capable of retaining an amount of water that is at least about five times the dry weight of the face fabric layer 12, as determined by ASTM Standard No. D4250-92. More preferably, the face fabric layer 12 should be capable of holding water in an amount that is at least about eight times the dry weight of the face fabric layer 12, as determined by ASTM Standard No. D4250-92.

Though the face fabric layer 12 preferably is hydrophillic, the face fabric layer 12 should preferably be capable of selectively releasing a large percentage of water that is held within the face fabric layer 12 by evaporation to maximize the available evaporative cooling period provided by the evaporative cooling fabric 10. Thus, the hydrophillicity of the face fabric layer 12 may be balanced against the releasable percentage of water held within the face fabric layer 12 to optimize the available evaporative cooling period. A measure of the ratio of readily evaporable water may be evaluated to optimize the available evaporative cooling period.

One measure of the ratio of readily evaporable water may be obtained by first determining the weight of sorptive water that accumulates in a particular sample of the face fabric layer 12, per ASTM Standard No. D5802-95. Then, the weight of water held in the particular sample of the face fabric layer 12, after excess water extraction, may be determined in accordance with ASTM Standard No. D4250-92. Finally, the weight of sorptive water that accumulates in the particular face fabric layer 12 sample, per ASTM Standard No. D5802-95, may be divided by the weight of water held in the particular face fabric layer 12 sample, after excess water extraction, per ASTM Standard No. D4250-92, to arrive at the measure of the ratio of evaporable water in the particular face fabric layer 12 sample. This measure of the ratio of readily evaporable water relies on the assumption that water extracted when conducting the procedure of ASTM Standard No. D4250-92 makes up most or all of the readily evaporable water contained in the face fabric layer 12. This measure of the readily evaporable water ratio is a reliable approach to comparing different samples of the face fabric layer 12 to each other in terms of relative ratios of evaporable water.

When the face fabric layer 12 is formed of hydrophillic fiber, the evaporable water ratio of the face fabric layer 12, determined in accordance with the measure of the evaporable water ratio that is set forth above, preferably ranges from about 6 to about 14 to optimize a relatively lengthy evaporative cooling period for the evaporative cooling fabric 10 versus a relatively high level of wicking by the fibers of the face fabric layer 12. More preferably, when the face fabric layer 12 is formed of hydrophillic fiber, the evaporable water ratio of the face fabric layer 12, ranges from about 7.5 to about 8.5 to further optimize the relatively lengthy evaporative cooling period for the evaporative cooling fabric 10 versus the relatively high level of wicking by the fibers of the face fabric layer 12.

The face fabric layer 12 may generally have a thickness A of about 1/16 inch (about 0.16 centimeters) to about 1 inch (about 2.54 centimeters). Preferably, however, the thickness A of the face fabric layer 12 ranges from about 1/16 inch (about 0.16 centimeters) to about ½ inch (about 1.27 centimeters). This range of thickness A has been found to be generally adequate for allowing a sufficient amount of evaporative cooling to maintain comfort levels for the user for periods on the order of about three to about four hours, or more.

In the fabric industry, the “weight” of a particular fabric is generally understood to mean the weight of the particular fabric per unit area of the particular fabric. Evaporative cooling performance of the evaporative cooling fabric 10 has been found to be generally adequate when the face fabric layer 12 has a weight ranging from about 4 ounces per square yard (about 135.6 grams per square meter) to about 12 ounces per square yard (about 406.9 grams per square meter). The weight of a particular fabric is highly dependent upon both the amount and nature of fibers used in the fabric and the degree of compression of the fibers within the fabric. Enhanced compression and consequent enhanced fiber density tends to reduce the amount of water that can be held within a particular fabric, though sufficient fiber density and compression is necessary to account for the surface tension of the water and allow for retention of water between fibers of the face fabric layer 12.

The individual fibers of the face fabric layer 12 may permissibly be either hydrophobic or hydrophillic. Hydrophobic fibers tend to absorb little, if any, water within the fiber itself, whereas hydrophillic fibers tend to absorb a significant amount of water within the fiber itself. Nonetheless, the individual fibers of the face fabric layer 12 are preferably hydrophillic, for a number of different reasons. First, when the face fabric layer 12 is placed against the skin of the user, hydrophillic fibers will tend to enhance wicking of moisture away from the skin and into the face fabric layer 12, and consequently, will help reduce the clammy feelings that can exist when perspiration remains on the skin surface. Thus, hydrophillic fibers will help enhance the comfort level of the user. Additionally, dirt tends to cling less easily to hydrophillic fibers, and stains tend to be more easily removed from hydrophillic fibers because water and detergents have more effect on the hydrophillic fibers. Also, hydrophillic fibers are typically more easily colored than hydrophobic fibers, since many clothing dyes are typically dissolved in aqueous solutions, as opposed to organic solvents.

The individual fibers of the face fabric layer 12 preferably also have a combination of cross-sectional shape and denier that enhances the ratio of fiber surface area to fiber volume. Enhancements in the ratio of fiber surface area to fiber volume help enhance the rate at which moisture is absorbed by individual fibers and additionally is believed to help enhance the capacity for absorption within fabrics between different fibers of the fabric. Additionally, enhanced fiber surface area to fiber volume ratios tend to enhance fiber retention of absorbed water and also tend to act as an additional control on the rate at which evaporation of water from fabrics formed of the fibers may occur.

As used herein, “denier” is a measure of the weight of a length of fiber that is used to characterize the thickness of the fiber. Higher denier means larger fibers, whereas smaller denier means finer fibers. When a fiber is one denier, this means that 9,000 meters (about 5 miles) of the fiber has a weight of about 1 gram. In the face fabric layer 12, the individual fibers may range from about 1 denier to about 10 denier. Also, the individual fibers in the face fabric layer 12 may have any cross-sectional shape or combination of cross-sectional shapes, such as round, square, rectangular, a T-shape, a Y-shape, an H-shape, and X-shape, or any of these with any number of longitudinal striations or serrations, or any of these in any combination.

The fibers of the face fabric layer 12 preferably range from about 1 denier to about 5 denier and have a cross-sectional shape approximating the cross-sectional shape of a fiber 26, as depicted in FIG. 2. The fiber 26 includes longitudinal lobes or ridges 28 that are dispersed about the perimeter of the fiber 26. The longitudinal ridges 28 define longitudinal serrations 30 in the fiber 26. More preferably, the fibers of the face fabric layer 12 range from about 1.5 denier to about 4 denier and have a cross-sectional shape identical to, or approximating that, of the fiber 26. Viscose rayon, one preferred fiber of the face fabric layer 12, generally has a cross sectional shape approximating the cross sectional shape of the fiber 26.

The fibers of the face fabric layer 12 may generally be formed of natural polymers or manmade polymers. Some non-exhaustive examples of suitable natural polymeric fibers include cotton, flax, wool, bagasse, jute, and silk. Some non-exhaustive examples of suitable synthetic polymeric fibers include cellulose-based materials, such as rayon, cellulose nitrate, cellulose acetate, cellulose triacetate; polyamides, such as nylon-6 or nylon-6,6; polyesters, such as polyethylene terephthalate; polyolefins, such as isotactic polypropylene or polyethylene; or any of these in any combination. Furthermore, the fibers of the face fabric layer 12 may be any combination of natural polymeric fibers and synthetic polymeric fibers.

Preferably, the fibers of the face fabric layer 12 are viscose rayon fibers, such as viscose rayon fibers available as GALAXY® RTM viscose rayon fibers from Courtaulds's PLC of London, England. Viscose rayon is rayon that is manufactured by treating cellulose with a caustic alkali solution and carbon disulfide. GALAXY® RTM viscose rayon fibers may be spun and dyed to form the face fabric layer 12 by American Felt and Filter Company of New Windsor, N.Y. GALAXY® RTM viscose rayon fibers are about 3 denier and have an absorbency of about 33.7 grams of water per gram of dry fiber.

When the non-woven fabric of the face fabric layer 12 is formed of viscose rayon fibers, the viscose rayon fibers are preferably intermingled mechanically, using an appropriate mechanical intermingling technology, such as needle-punching, hydro-entangling jets, or air jets, and are more preferably mechanically intermingled using needle-punching. Chemical intermingling of the fibers, such as the viscose rayon fibers, to form the non-woven fabric of the face fabric layer 12 may permissibly be employed using chemical binders or chemical adhesives. However, chemical intermingling is preferably not used, since the addition of chemical binders or chemical adhesives to form the non-woven fabric of the face fabric layer 12 undesirably increases the weight of each fiber incorporated in the face fabric layer 12. Additionally, chemical intermingling covers a portion of the surface of fibers and consequently prevents the chemically covered surfaces of the fibers from absorbing liquid water. Instead, as indicated above, mechanically intermingling techniques are preferably employed to minimize any degradation of the liquid water absorption capabilities of the fibers, such as the viscose rayon fibers.

Additionally, all, or predominantly all, of the fibers that make up the face fabric layer 12 are preferably thermoplastic. These fibers are preferably thermoplastic to allow the fibers to melt without degrading polymeric components of the fibers. It is preferred that these fibers of the face fabric layer 12 be thermoplastic, and therefore capable of melting, to allow hot calendaring of the surfaces of the face fabric layer 12, especially surfaces of the face fabric layer 12 that will be placed in contact with the body of a user.

Hot calendaring is beneficial for accomplishing a couple of different objectives. First, hot calendaring, which is well-known to those of ordinary skill the art of non-woven fabric manufacturing and processing, helps improve the integrity and abrasion resistance of the surface of the face fabric layer 12. Secondly, hot calendaring helps soften the hand of the hot calendared surfaces. Briefly, the “hand” of a fabric refers to the feel of the fabric, when handled. A fabric is considered to have a soft hand when the fabric is relatively soft and non-abrasive when felt with the hand. Provision of a soft hand to the surface 18 of the face fabric layer 12 that is placed in contact with the body of a user will help make that contact between the surface 18 of the face fabric layer 12 and the body of the user more comfortable to the user. Another reason for favoring thermoplastic fibers is to allow for optional thermal fusion of the face fabric layer 12 with another layer in alternative forms of the inventive evaporative cooling fabric.

The backing fabric layer 14, as in FIG. 1, may be a woven fabric. Again, as used herein, a “woven fabric” is a fabric that is produced when at least two sets of fibers or strands are interlaced, usually, but not necessarily, at right angles to each other, according to a predetermined pattern of interlacing. In woven fabrics, at least one set of fibers or strands is oriented parallel to a longitudinal axis along the longest dimension of the fabric. The backing fabric layer 14 is preferably formed as woven fabric to introduce a select and relatively uniform degree and pattern of porosity, and thus a controlled level of porosity, into the backing fabric layer 14. This controlled level of porosity helps control the rate at which air is able to pass into the backing fabric layer 14. Consequently, this controlled level of porosity allows the backing fabric layer 14 to control the rate at which water is evaporated from the face fabric layer 12, and consequently control the rate of cooling provided by the evaporative cooling fabric 10 to the body of the user. Also, this controlled porosity of the backing fabric layer 14 controls and helps extend the available cooling period of the evaporative cooling fabric 10 by controlling the water evaporation rate from the face fabric layer 12.

Though the backing fabric layer 14 is preferably woven in form, other forms of the backing layer 14 are permissible. These alternative forms of the backing fabric layer 14, while permissible, preferably have a controlled level of porosity that helps control the rate at which air is able to pass into the backing fabric layer 14, as in the preferred woven form of the backing fabric layer. Also, these alternative forms of the backing fabric layer 14 are preferably not wind-proof, since some air flow is preferably able to pass in and through any of each alternative form of the backing fabric layer 14 to trigger vaporization and consequent evaporation of water from the face fabric layer 12 of the evaporative cooling fabric 10.

The preferred woven nature of the backing fabric layer 14, as noted above, helps control the porosity of the backing fabric layer 14, which in turn helps control the cooling rate provided by the evaporative cooling fabric 10 and helps extend the available cooling period of the evaporative cooling fabric 10. Generally, to provide a sufficient amount of evaporative cooling that maintains comfort levels for the user for periods on the order of about three hours to about four hours, or more, the porosity of the backing fabric layer 14 may be selected to provide the backing fabric layer 14 with an air permeability ranging from about 20 cubic feet of air per minute (about 0.56 cubic meters per minute) to about 100 cubic feet of air per minute (about 2.83 cubic meters per minute). More preferably, the porosity of the backing fabric layer 14 provides the backing fabric layer 14 with an air permeability ranging from about 30 cubic feet per minute (about 0.85 cubic meters per minute) to about 80 cubic feet per minute (about 2.26 cubic meters per minute), and most preferably with an air permeability ranging from about 30 cubic feet per minute (about 0.85 cubic meters per minute) to about 50 cubic feet per minute (about 1.42 cubic meters per minute).

As used herein, the term “air permeability” means “the rate of air flow through a fabric under a differential pressure between the two major surfaces of the fabric.” Also, as used herein, the term “porosity” means “the ratio of the volume of air or voids contained within the boundaries of a material to the total volume (solid matter plus air or voids) of the material, expressed as a percentage.” The air permeability of a particular fabric, such as the backing fabric layer 14, expressed on the basis of the volumetric rate of air flow through the fabric, may be determined in accordance with ASTM Standard No. D737-96, that is entitled Test Method for Air Permeability of Textile Fabrics. A copy of ASTM Standard No. D737-96 may be obtained from the American Society for Testing and Materials of West Conshohocken, Pa.

The backing fabric layer 14 may be formed of a plurality of strands of yarn (not shown) that may collectively form the preferred woven fabric of the backing fabric layer 14. The yarn strands, which are formed of fibers, are spaced apart in the preferred woven fabric to provide the backing fabric layer 14 with the described air permeability characteristics. The fibers of the backing fabric layer 14 may generally range from about 20 denier to about 80 denier to provide the range of porosity that is useful for attaining the described air permeability parameters. Yarn formed of fibers with deniers higher than about 80 denier provide the backing fabric layer 14 with a more textured surface that makes it more difficult, or even impossible, to attain the desired air permeability parameters of the backing fabric layer 14. Also, yarns formed of higher denier fibers are more difficult to wash and have a higher propensity for becoming frayed during use and during washing operations. On the other hand, yarns formed of fibers lower than about 20 denier tend to be less durable and, when prepared in a tight weave, tend to reduce the air permeability parameters below desirable levels. The backing fabric layer 14 is preferably formed of fibers that range from about 25 denier to about 75 denier, and still more preferably is formed of fibers that range from about 25 denier to about 35 denier, with about 30 denier being most preferred.

Generally, in keeping with the desired denier ranges of the fibers and the desired air permeability parameters of the backing fabric layer 14, the backing fabric layer 14 may have a weight ranging from about 0.1 ounce per square yard (about 3.4 grams per square meter) to about 3 ounces per square yard (about 101.7 grams per square meter). Preferably, the weight of the backing fabric layer 14 ranges from about 0.8 ounces per square yard (about 27.1 grams per square meter) to about 2 ounces per square yard (about 67.8 grams per square meter) to provide the backing fabric layer 14 with a softer hand that is aesthetically pleasing to the user and helps minimize the overall weight of the evaporative cooling fabric 10. Most preferably, to optimize the strength of the backing fabric layer 14 while maintaining an acceptable hand softness and light weight, the backing fabric layer 14 has a weight ranging from about 1.0 ounces per square yard (about 33.9 grams per square meter) to about 1.7 ounces per square yard (about 57.6 grams per square meter). To accommodate the fiber denier, fabric weight, and air permeability parameters described above, it has been found that the backing fabric layer 14 may generally have a thickness B ranging from about 0.5 millimeters to about 5 millimeters, with a thickness B ranging from about 0.8 millimeters to about 1.5 millimeters being preferred.

The individual fibers of the backing fabric layer 14 may permissibly be either hydrophobic or hydrophillic. Hydrophobic fibers tend to absorb little, if any, water within the fiber itself, whereas hydrophillic fibers tend to absorb a significant amount of water within the fiber itself. Hydrophobic fibers are preferred for the backing fabric layer 14, since hydrophobic fibers tend to better maintain control of the rate of water evaporation from the face fabric layer 12 through the pores of the backing fabric layer 14. Beyond helping enhance the wear properties of the evaporative cooling fabric 10, one important purpose of the backing fabric layer 14 is to help control the rate of water evaporation from the face fabric layer 12, and consequently the rate and duration of evaporative cooling provided by the evaporative cooling fabric 10.

Hydrophillic fibers that may be incorporated in the backing fabric layer 14 introduce a wicking aspect that further enhances the rate of water evaporation from the evaporative cooling fabric 10. This wicking effect of any hydrophillic fibers included in the backing fabric layer 14 may tend to degrade the control effect of the backing fabric layer 14 on the rate of evaporative cooling provided by the evaporative cooling fabric 10. Nonetheless, recognizing this potential drawback to using hydrophillic fibers, hydrophillic fibers do have some advantageous properties. For example, hydrophillic fibers tend to become dirty less easily than hydrophobic fibers. Also, stains tend to be more easily removed from hydrophillic fibers than from hydrophobic fibers. On the other hand, the backing fabric layer 14 maybe made of hydrophobic fibers that are dyed in darker colors to better hide visible dirt and stains, since clothing colorants, though more readily available for hydrophillic fibers are, nonetheless, available for hydrophobic fibers.

The fibers of the backing fabric layer 14 may generally be formed of synthetic polymers. Some non-exhaustive examples of suitable synthetic polymeric fibers include polyamides, such as nylon-6 or nylon-6,6; polyesters, such as polyethylene terephthalate; polyolefins, such as isotactic polypropylene or polyethylene; acetate polymers, such as cellulose acetate; acrylic polymers; or any of these in any combination. Preferably, the backing fabric layer 14 is formed of ripstop nylon, such as ripstop nylon-6,6, that has been dyed black in color. Those of ordinary skill in the art will recognize that ripstop nylon may be obtained from a number of different suppliers. One suitable source for ripstop nylon fabric in either nylon-6 or nylon-6,6 is E.I. duPont de Nemours and Co. of Wilmington, Del. One preferred form of ripstop nylon is made of about 30 denier nylon fibers, preferably about 30 denier ripstop nylon-6,6 fibers, has a weight of about 1.1 ounces per square yard (about 37.3 grams per square meter), and has an air permeability value, determined in accordance with ASTM Standard No. D737-96, of about 40 cubic feet per minute (about 1.1 cubic meters per minute).

The backing fabric layer 14 is wind-resistant to permit the backing fabric layer 14 to control, but not eliminate, air flow into the backing fabric layer 14 that supports evaporation of water from the face fabric layer 12. Thus, the backing fabric layer 14 is not wind-proof. To minimize, or even eliminate flow of water, such as rainfall, in a reverse direction from the outer surface 24 of the backing fabric layer 14, through the backing fabric layer 14, and into the face fabric layer 12, a suitable water-resistant coating may be applied to the outer surface 24. This coating (not shown), if applied, must not occlude all of the pores or spaces between woven fibers of the backing fabric layer 14, since such occlusion would degrade the evaporative cooling effect exhibited by the evaporative cooling fabric 10 of the present invention. Instead, any water-resistant coating that is applied to the outer surface 24 should preserve most, and preferably all, of the pores or spaces between fibers of the backing fabric layer 14 that are present prior to application of the water-resistant coating to provide the backing fabric layer 14 with the described air permeability parameters.

The adhesive layer 16 that is located between, and in contact with, the face fabric layer 12 and the backing fabric layer 14 serves at least a couple of important purposes. First, the adhesive layer 16 secures the backing layer 14 and the face fabric layer 12 in working relation with each other. Consequently, the adhesive layer 16 maintains the backing fabric layer 14 in close proximity to, and permissibly even in contact with, the face fabric layer 12. Preferably, the adhesive layer 16 maintains discrete portions of the face fabric layer 12 in fixed relation with associated discrete portions of the backing fabric layer 14 to predominantly prevent, and more preferably fully prevent, any portions of the face fabric layer 12 from shifting or sliding relative to any associated portions of the backing fabric layer 14.

While maintaining this working relation between layers 12, 14, the adhesive layer 16 preferably prevents, or predominantly prevents, delamination of the face fabric layer 12, relative to the backing fabric layer 14, and vice versa, during use of the fabric 10 for evaporative cooling and during storage and laundering of the fabric 10. Furthermore, the adhesive layer 16 preferably prevents, or predominantly prevents, fraying of the face fabric layer 12 and the backing fabric layer 14 about a perimeter 32 of the evaporative cooling fabric 10. Indeed, it has been found that the perimeter 32 of the evaporative cooling fabric 10 may be left as a raw edge that is exposed during use without having to incorporate any finishing techniques, such as hemming, to create a finished edge.

As an additional benefit, the adhesive layer 16 that effectively laminates the layers 12, 14, 16 together as the evaporative cooling fabric 10 causes the evaporative cooling fabric 10 to have greater strength and greater resiliency, than either the layer 12 or the layer 14 possess individually. Furthermore, when the face fabric layer 12 is formed of fibers susceptible to shrinkage, such as cotton and/or rayon, the composite laminate of the layers 12, 14, 16 significantly offsets and mitigates any shrinkage tendency in the face fabric layer 12 that would otherwise exist.

The adhesive layer 16 preferably overlaps most, and more preferably all, portions of the surface 20 that overlap the surface 22 and preferably overlaps most, and more preferably all, portions of the surface 22 that overlap the surface 20. However, though the adhesive layer 16 is preferably continuous in nature, the continuous nature of the adhesive layer 16 should not significantly interfere with passage of air through the backing fabric layer 16 and into the face fabric layer 12. Though controlling air flow, the backing fabric layer 14 allows air flow that supports evaporation of water from the face fabric layer 12 and consequently helps control the extent and duration of body cooling by the evaporative cooling fabric 10. Likewise, the continuous nature of the adhesive layer 16 should not significantly interfere with evaporation of water from the face fabric layer 12 through the backing fabric layer 14. Preferably, the adhesive layer 16, when continuous in form, does not interfere, or only negligibly interferes, with air flow through the backing fabric layer 14 into the face fabric layer 12 and with evaporation of water from the face fabric layer 12 through the backing fabric layer 14.

One form of the adhesive layer 16 that is continuous and accomplishes these objectives of only minimally, or preferably only negligibly, interfering with air flow and water evaporation through the backing fabric layer 14 is a layer of adhesive foam. Generally, this adhesive foam may range from about ½ millimeter in thickness up to about 10 millimeters in thickness, though a thickness of the foam on the order of about 1 millimeter is preferred. The foam that serves as the adhesive layer 16 may generally be formed of hydrophillic polymeric material, hydrophobic polymeric material, or any combination of these.

The adhesive foam should be open cell in structure, rather than closed cell, to minimize or prevent disruption of air flow from the backing fabric layer 14 into the face fabric layer 12 and evaporation of water from the face fabric layer 12 into the backing fabric layer 14. Ether-based polyurethane foams and polyester foams are some non-exhaustive examples of the adhesive foam layer that may serve as the adhesive layer 16.

The adhesive foam layer may be transformed into the adhesive layer 16 by positioning the foam layer between the face fabric layer 12 and the backing fabric layer 14. Thereafter, the composite of the layers 12, 14, and 16 may be subjected to compression heating using conventional industrial heat pressing equipment, such as a George Knight No. 374 industrial heat press, at a suitable temperature, pressure, and time duration, such as about 200° F. (about 93° C.) at about 3 pounds per square inch (psi) (about 155 millimeters of mercury) for about 10 seconds, to bond the layers 12, 14, 16 together. A George Knight No. 374 industrial heat press may be obtained from Geo. Knight & Co. Inc., of Brockton, Ma.

As another alternative, the adhesive foam layer may be passed through an open flame at a suitable rate, such as about 110 feet per minute (about 33.5 meters per minute), to cause surface melting of the adhesive foam layer. After passing the adhesive foam layer through the open flame, the layers 12, 14 and 16, with the layer 16 positioned between the layers 12 and 14, may be passed through a conventional system of compression rollers to laminate the layers 12, 14, 16 together. The strength of the laminate bond between the layers 12, 14, 16 is preferably maximized, by selecting an appropriate combination of line speed, flame intensity, and compression amount. Selection of an appropriate combination of line speed, flame intensity, and compression amount to enhance the strength of the bond between the layers 12, 14, 16 is well within the ability of those of ordinary skill in the art of heat-based lamination techniques.

Though the adhesive layer 16, such as the layer of adhesive foam, may be either hydrophillic or hydrophobic, the adhesive layer 16, when continuous in form, is preferably hydrophillic in nature to complement any water wicking properties of the face fabric layer 12. The adhesive layer 16 preferably bonds the layers 12, 14 in working relation with each other within the evaporative cooling fabric 10 without degrading mass transfer of air from the layer 14 to the layer 12 and without degrading mass transfer of water from the layer 12 to the layer 14. Thus, the adhesive layer 16 secures the layers 12 and 14 in working relation with each other while effectively being invisible for purposes of air flow and water flow.

When the adhesive layer 16 is formed of a conventional liquid or hot melt adhesive, such as a hot melt polyurethane sheet adhesive, the adhesive layer 16 should be laid down as a discontinuous layer to help minimize, and preferably prevent or only negligibly cause, any degradation of air flow through the layer 14 into the layer 12 and help minimize, and preferably prevent or only negligibly cause, any degradation of water evaporation from the layer 12 and into the layer 14. Such a discontinuous form of the adhesive layer 16 is best depicted at 34 in FIG. 3. Here, the discontinuous adhesive layer 34 is formed as a pattern of laced filaments 36 that define a discontinuous matrix of the adhesive layer 16. In FIG. 3, the face fabric layer 12 faces the viewer, and the adhesive layer 16 and the backing fabric layer 14 are depicted in phantom (shown with dashed lines), since the face fabric layer 12 faces the viewer, and the adhesive layer 16 and the backing fabric layer 14.

Throughout the drawings, like elements are referred to using like reference characters.

The discontinuous adhesive layer 34 that forms the pattern of laced filaments 36 may be prepared by extruding a liquid polymeric adhesive, such as a liquid polyurethane-based adhesive, from a nozzle onto a flat forming surface. After solidification, the pattern of laced filaments 36 remains as the adhesive layer 16. nonepreferred form, individual laced filaments 37 of the pattern 36 are on the order of about one denier, and adjacent filaments 37 are spaced apart from each other by about 1.5 millimeters. The laced filament pattern 36 that forms the discontinuous adhesive layer 34 may then be positioned between the layers 12, 14 for subsequent lamination using a conventional industrial heat press, such as the described George Knight No. 374 industrial heat press.

The discontinuous adhesive layer 34 helps minimize, though not fully preventing, interference of the adhesive layer 16 with air flow from the backing fabric layer 14 to the face fabric layer 12 and helps minimize, though not fully preventing, interference with water evaporation from the face fabric layer 12 into and through the backing fabric layer 14. However, since this discontinuous form of the adhesive layer 16 does not bond all overlapping portions of the layers 12, 14 together as part of the evaporative cooling fabric 10, use of the described adhesive foam layer, in continuous fashion, as the adhesive layer 30 is preferred over use of the discontinuous adhesive layer 34 as the adhesive layer 16. In essence, the continuous form of the adhesive layer 16 provides the laminate of the layers 12, 14, 16 with improved strength and resiliency, as compared to the discontinuous adhesive layer 34.

The evaporative cooling fabric 10 may include additional layer(s) beyond the face fabric layer 12, the backing fabric layer 14, and the adhesive layer 16. Preferably, however, the face fabric layer 12 and the backing fabric layer 14 form the outermost layers of the evaporative cooling fabric 10, and any additional layer(s) is positioned between the face fabric layer 12 and the backing fabric layer 14. Also, though it is permissible to include additional layer(s) beyond the face fabric layer 12, the backing fabric layer 14, and the adhesive layer 16, any additional layer(s) should preferably not significantly interfere with air flow from the backing fabric layer 14 to the face fabric layer 12 and should preferably not interfere with water evaporation from the face fabric layer 12 into and through the backing fabric layer 14. The additional layer(s) may be attached between the layers 12, 14 in any fashion; preferably, the attachment mechanism for the additional layers maintains discrete portions of the face fabric layer 12 in fixed relation with associated discrete portions of the backing fabric layer 14 to predominantly prevent, and more preferably fully prevent, any portions of the face fabric layer 12 from shifting or sliding relative to any associated portions of the backing fabric layer 14.

As yet another alternative, the face fabric layer 12 may be directly bonded to the backing fabric layer 14 to form an evaporative cooling fabric 38, as best depicted in FIG. 4. The evaporative cooling fabric 38 dispenses with the adhesive layer 16 that is present in the evaporative cooling fabric 10. The evaporative cooling fabric 38 that excludes the adhesive layer 16 may be formed when thermoplastic fibers are incorporated in both the face fabric layer 12 and the backing fabric layer 14. Heat, such as direct flame lamination, is applied to the surface 20 of the face fabric layer 12 and to the surface 22 of the backing fabric layer 14 to melt the thermoplastic fibers of the layers 12, 14. Thereafter, the layers 12, 14 are passed through a compression roller (not shown) with cooling to cause molten thermoplastic fibers of the layers 12, 14 proximate the surfaces 20, 22 to adhesively bond, solidify, and join with each other.

When this heat lamination technique is used to form the evaporative cooling fabric 38, a sufficient amount of the fibers in the layers 12, 14, distributed in substantially uniform fashion about the layers 12, 14, should be present to form a strong and integral bond between the layers 12, 14. Preferably, when thermal fusion between thermoplastic fibers of the layers 12, 14 is used to form the evaporative cooling fabric 38, at least about 50 percent of the fibers in both the layers 12 and 14, and more preferably at least about 75 percent of the fibers in both the layers 12, 14, are thermoplastic and participate in the thermal fusion between the layers 12, 14 to enhance the strength of the bond between the layers 12, 14.

As another alternative, the layers 12, 14 may be placed in working relation with each other, in the evaporative cooling fabric 10, or the evaporative cooling fabric 38, using any other conventional attachment technique beyond the attachment techniques previously described herein. For example, the layers 12, 14 may be sewed together using thread. Other conceivable attachment techniques for the layers 12, 14, as part of the evaporative cooling fabric 10, include use of pressure sensitive adhesive as the adhesive layer 16, or injection compression molding or injection molding of the adhesive layer 16 that secures the layers 12, 14 together in a working relation.

Nonetheless, despite these permissible alternative techniques for attaching the layers 12, 14 in working relation, formation of the evaporative cooling fabric 10 using the described adhesive foam layer as the adhesive layer 16 is preferred. The adhesive foam layer provides a continuous attachment mechanism for the layers 12, 14, while only minimally, and preferably only negligibly or not at all, interfering with air flow through the backing fabric layer 14 to the face fabric layer 12 and with evaporation of water from the face fabric layer 12 to and through the backing fabric layer 14. Also, as explained, continuous attachment of the layers 12, 14 in working relation helps enhance the strength and resiliency properties that are collectively exhibited by the layers 12, 14.

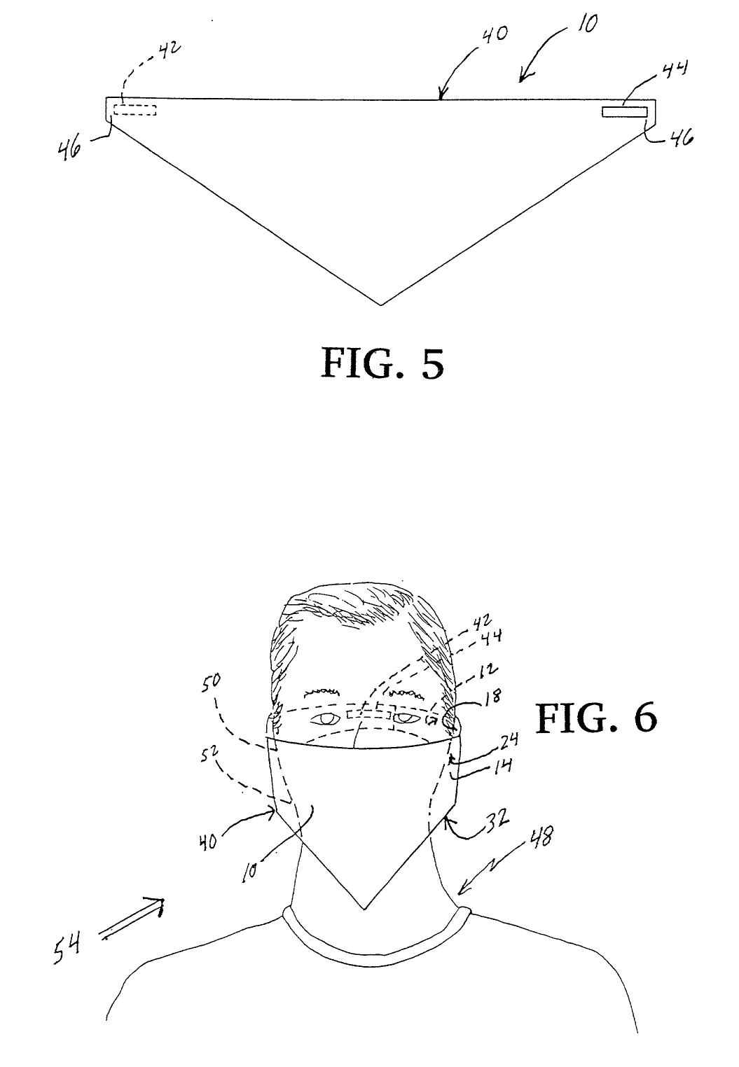

The evaporative cooling fabric 10 and the evaporative cooling fabric 38 may be cut in any desired shape to form articles of clothing that are fastenable against or around the body, or any body portion, of the user. As one example, the evaporative cooling fabric 10 or the evaporative cooling fabric 38 may be cut in a triangular shape that is usable as a bandana 40, as best depicted in FIG. 5. The bandana 40 is provided with a suitable attachment mechanism, such as a VELCRO® hook 42 and loop 44 fastening mechanism. Other non-exhaustive examples of suitable fastening mechanisms beyond hook 42 and loop 44 types of fastening mechanisms include zippers, snaps, buttons, clasps, and rings. Furthermore, opposing ends 46 of the garment, such as the bandanna 40, may be tied together to secure the evaporative cooling fabric 10 or 38.

Though subsequent references to the evaporative cooling fabric are made in terms of the evaporative cooling fabric 10, it is to be understood that these references are equally applicable to the evaporative cooling fabric 38, unless otherwise indicated.

The garment that is formed of the evaporative cooling fabric 10, such as the bandana 40, may be applied against, or even wrapped around a portion of a user's body, as generally depicted at 48 in FIG. 6. For example, the bandana 40 that may be formed of the evaporative cooling fabric 10 may be applied against a user's head and neck, as best depicted at 50 and 52, respectively, in FIG. 6. The surface 18 of the face fabric layer 12 of the evaporative cooling fabric 10 maybe placed in direct contact with the user's head 50 and neck 52. After being placed against the body 48, the hook 42 and loop 44 attachment mechanism may be engaged to secure the bandana 40 against the body 48.

Besides the head 50 and neck 52, articles formed of the evaporative cooling fabric 10, such as the bandanna 40, may be formed for wrapping about any other portion of the body 48 that the user desires to cool, such as a forearm, wrist, thigh, or abdomen (not shown) of the user. Furthermore, the evaporative cooling fabric 10 may be formed as an article of clothing, such as a pair of pants or a shirt, to cover larger areas of a person's body. As another alternative, the evaporative cooling fabric 10 may be formed as a glove (not shown) that fits onto the hand of the user. When the evaporative cooling fabric 10 is formed as a glove, the hand of the user is inserted into a cavity of the glove, where the cavity of the glove is defined by the surface 18 of the face fabric layer 12, to position the surface 18 of the face fabric layer 12 in contact with the user's hand. As another alternative, the evaporative cooling fabric 10 may be formed as hat (not shown) that fits onto the head of a user. When the evaporative cooling fabric 10 is formed as a hat, a cavity of the hat is defined by the surface 18 of the face fabric layer 12, and the hat is positioned on the user's head with the head located within the cavity of the hat to position the surface 18 of the face fabric layer 12 in contact with the user's head.

No matter the form or shape of the article that is formed of the evaporative cooling fabric 10, the surface 18 of the evaporative cooling fabric 10 may be positioned against, or in close proximity to, the skin of the user. This arrangement allows the evaporative cooling fabric 10 to provide the cooling effect of the present invention to the body 48 of the user. The benefits of the present invention are most clearly exhibited when there is a source of moving air, such as wind 54, that is forced against the surface 24 of the backing fabric layer 14. Specifically, the flow of wind into and through the backing fabric layer 14 of the evaporative cooling fabric 10 and the consequent evaporation of water through the surface 24 generates the beneficial cooling effect of the evaporative cooling fabric 10. A lessor amount of additional cooling effect is beneficially generated by flow of wind about the perimeter 32 of the evaporative cooling fabric 10 and the consequent evaporation of water from the perimeter 32 of the evaporative cooling fabric 10 and from any portions of the surface 18 of the face fabric layer 12 not in contact with the body 48 of the user of the evaporative cooling fabric 10.

Also, though the sweat of a user, such as a person, may provide the water source for the face fabric layer 12, the cooling effect of the inventive evaporative cooling fabric 10 may be initiated earlier, or at an enhanced rate, by adding water to the face fabric layer 12, either before or after the evaporative cooling fabric 10 has been positioned against the skin of the user. The water may be added in any fashion, such as by pouring the water onto the face fabric layer 12 or by soaking the evaporative cooling fabric 10 in a pail of water. Even when the water source to the evaporative cooling fabric is water that is added only once to initiate the evaporative cooling effect, the evaporative cooling effect will, in many circumstances, extend over long periods of time on the order ranging from about three hours to even about four hours or more. This is especially beneficial for those participating in participating in strenuous activities, such as bicycle or motorcycle riding, for longer periods of time.

As an alternative to pouring water onto the face fabric layer 12 or soaking the evaporative cooling fabric 10 in water, an exterior water source (not shown), such as a portable water pouch or container, may be placed in fluid connection (via flexible tubing, for example) with the evaporative cooling fabric 10. The exterior water source may be selectively or automatically activated to periodically, or even continuously, replenish the face fabric layer 12 with water to support continued evaporative cooling by the evaporative cooling fabric 10. As yet another alternative, a portion of the evaporative cooling fabric 10 may be formed to include a pouch portion (not shown) as part of, or in fluid communication with, the face fabric layer 12. Ice maybe place in the pouch portion. Water formed when the ice melts helps replenish the evaporative cooling capacity of the evaporative cooling fabric 10. Also, the ice itself, and heat absorption that occurs upon melting of the added ice adds an additional source of cooling to the evaporative cooling fabric 10.

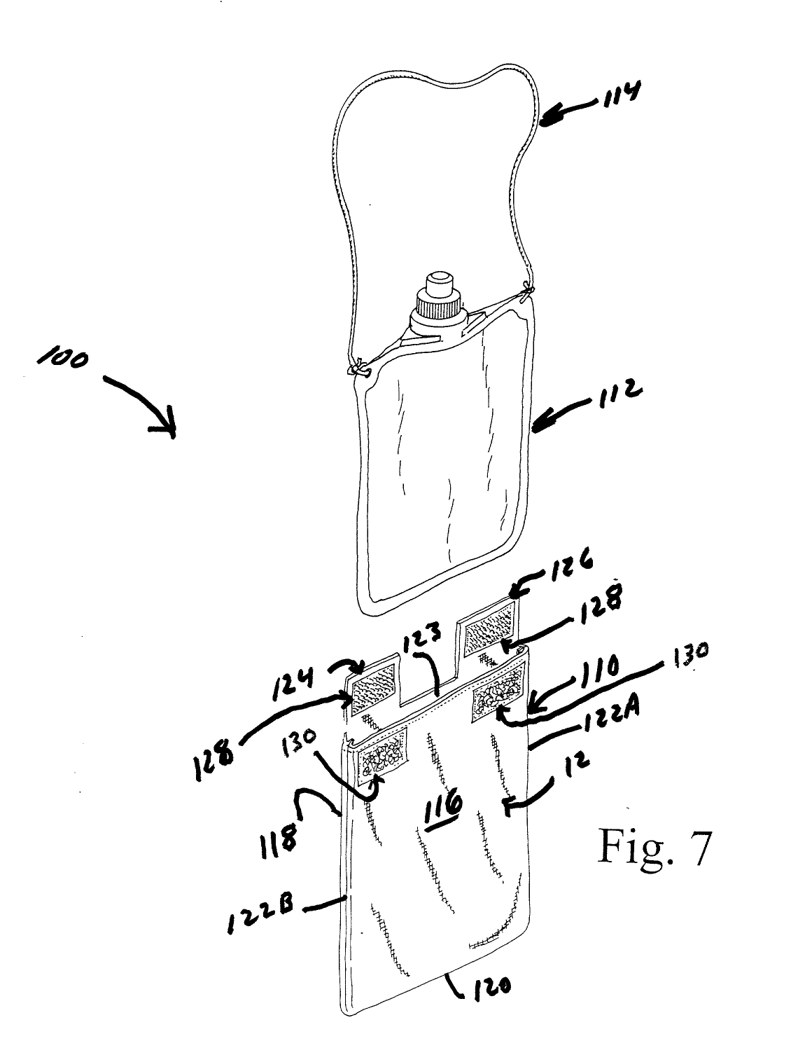

In addition to the evaporative cooling fabric 10, the face fabric layer 12 may also be incorporated in an evaporative cooling system of the present invention, as depicted at 100 in FIG. 7. The evaporative cooling system 100 includes an evaporative cooling article, which maybe configured as an evaporative cooling pouch 110, and a liquid holding container 112 that may be enclosed within the pouch 110. The system 100 may incorporate a strap 114 that may be attached to either the pouch 110 or to the container 112. The strap 114 permits the cooling system 100 to be hung from any suitable location, such as a user's neck or shoulder, that exposes the pouch 110 to atmosphere and preferably to a current of air, such as wind.

The pouch 110 may permissibly be formed from the face fabric layer 12 only, such as a single layer of the face fabric layer 12. The details of the face fabric layer 12, and consequently of the pouch 110 that is formed from the face fabric layer 12 only, are the same as the details provided for the face fabric layer 12 of the evaporative cooling fabric 10, unless otherwise indicated herein. For example, the pouch 110 preferably has the super absorbent qualities of the face fabric layer 12, and thus preferably exhibits the beneficial water holding capacity and evaporative qualities of the face fabric layer 12. The pouch 110 may be fashioned to allow the face fabric layer 12 of the pouch 110 to closely confront, and be in contact with, the container 112. More preferably, contact between the container 112 and the pouch 110 is maximized.

Some non-exhaustive examples of the container 112 of the evaporative cooling system 100 include canteens, cans, bottles, bags and drink boxes. The container 112 may generally be made of any material, such as glass, plastic, cardboard, metal or any other material, so long as the selected material is capable of holding a liquid to be cooled using the evaporative cooling system 100. Some non-exhaustive examples of liquids that maybe held within the container 112 include water, energy drinks, soda pop, fruit juices, and alcoholic beverages.

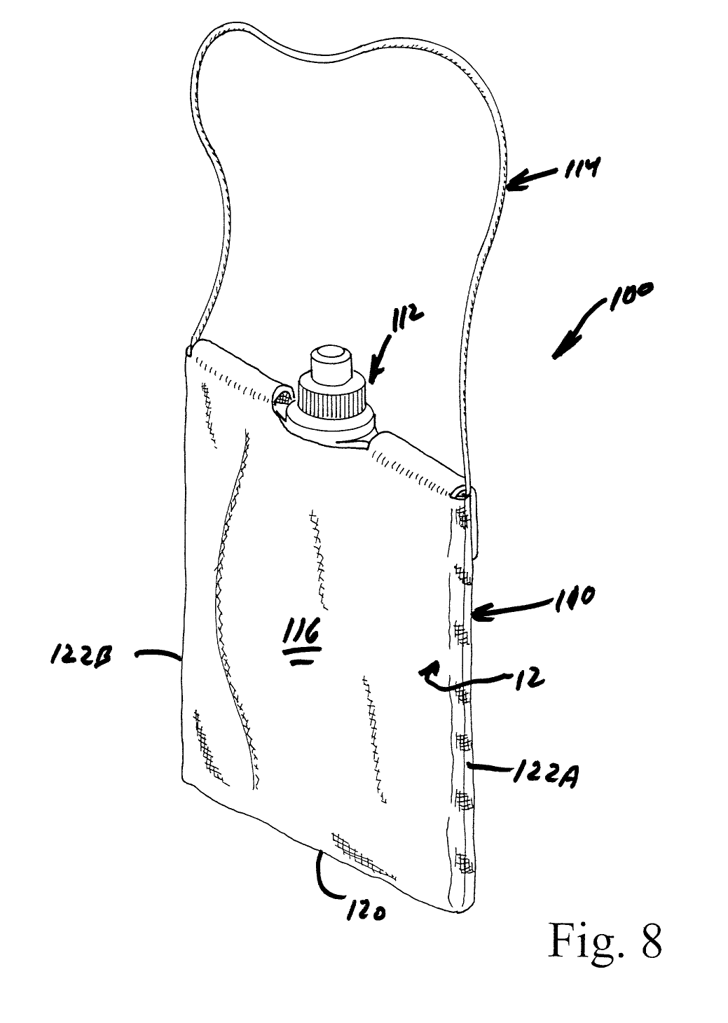

The pouch 110 is fashioned to at least partially, and preferably substantially (as best depicted in FIG. 8), enclose the exemplary container 112. Returning to FIG. 7, the pouch 110 may include a first sheet 116 of the face fabric layer 12 and a second sheet 118 of the face fabric layer 12 that are joined together along a bottom edge 120 and along side edges, 122a and 122b of the pouch 110. The sheets 116, 118 collectively define a cavity (not shown) in which the container 112 may be positioned via an opening 123 of the cavity.

After the container 112 is insertable within the pouch 110, the container 112 may be secured within the pouch 110 by a first clasp 124 and a second clasp 126, or any other conventional securing mechanism. Each clasp 124, 126 extends from the first sheet 116 of the pouch 110. Preferably, both of the clasps 124, 126 include first hook and loop fasteners 128 that are releasably mateable with second hook and loop fasteners 130 that are fixed attached to the second sheet 118 of the pouch 110. However, it is within the scope of the present invention to include alternative means for releasably attaching the clasps 124, 126, to the second sheet 118 of the pouch 110. Some non-exhaustive examples of suitable alternative releasable attachment mechanisms include snaps, a button and loop mechanism, adhesives, and a string and hook mechanism. Upon insertion of the container 112 within the pouch 110 and engagement of the clasps 124, 126 with the fasteners 128, the clasps 124, 126 secure the sheets 116, 118 together proximate the opening 123 and consequently secure the container 112 within the pouch 110. The container 112 may be removed from the pouch 110 for any purpose, such as for cleaning the pouch 110 of the container 112.

The sheets 116, 118 of the pouch 110 may permissibly each be formed from two or more of the layers 12 that are preferably secured in registry with each other. Multiple layers 12 that may be used to form the sheets 116, 118 of the pouch 110 may be secured in registry with each other in any conventional fashion, such as by sewing the layers 12 together, laminating the layers 12 together, or adhesively securing the layers 12 together. Preferably, the multiple layers 12, when used to form the pouch 110, are secured together via a technique that only negligibly causes, and more preferably prevents, any degradation of the water evaporation rate from, mass transfer within, and cooling capacity of the multiple layers 12.

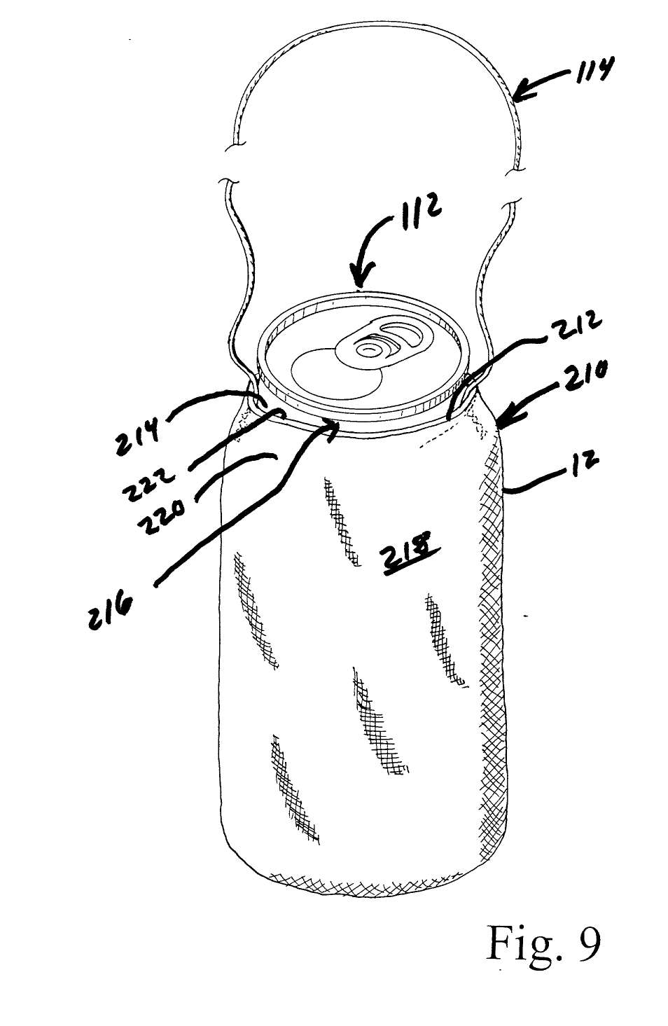

The evaporative cooling system may alternative include an evaporative cooling pouch 210, as depicted in FIG. 9, in place of the evaporative cooling pouch 110. Like the pouch 110, the pouch 210 may be configured to accept and enclose the liquid holding container 112. Like the pouch 110, the pouch 210 may be formed of only, or include, the face fabric layer 12. The pouch 210 may be similar in appearance and configuration to traditional foam “huggie” type of beverage can coolers and beverage bottle coolers that are well known to those of ordinary skill in the art.

The pouch 210 may be formed from a single sheet 212 of the face fabric layer 12 that is stitched together at adjoining edges (not shown) to form the pouch 210. The sheet 212, as stitched together at adjoining edges, defines a cavity 214 in which the container 112 may be positioned via an opening 216 of the cavity 214. The pouch 210 may permissibly include two or more of the layers 12 that are preferably secured in registry with each other. Multiple layers 12 that may be used to form the pouch 210 may be secured in registry with each other in any conventional fashion, such as by sewing the layers 12 together, laminating the layers 12 together, or adhesively securing the layers 12 together. Preferably, the multiple layers 12, when used to form the pouch 210, are secured together via a technique that only negligibly causes, and more preferably prevents, any degradation of the water evaporation rate from, mass transfer within, and cooling capacity of the multiple layers 12.

The pouch 210 may, and preferably does, include an elastic netting layer 218 that is secured to either an outer surface 220 or an inner surface 222 of the face fabric layer 12 or may be embedded or integrally incorporated within the face fabric layer 12 in conventional fashion. The elastic netting layer 218 allows the container 112 to be elastically and releasably secured within the pouch 210 without the need for any additional securing mechanisms beyond the elastic netting layer 218. Preferably, the elastic netting layer 218, if used, only negligibly causes, and more preferably prevents, any degradation of the water evaporation rate from, mass transfer within, and cooling capacity of the multiple layers 12.

The super absorbent quality of the face fabric layer 12, when incorporated with the pouches 110, 210, helps cool liquid contained within the container 112 via evaporative cooling and/or conductive cooling and preferably a combination of both evaporative and conductive cooling. Through conductive cooling, thermal energy of the liquid contained within the container 112 may be transferred to water held within the pouches 110, 210, if the water held within the pouches 110, 210 has a lower temperature than the fluid liquid the container 112. Via evaporative cooling using the pouches 110, 210, the temperature of the liquid within the container 112 may be cooled to a temperature that is lower than the ambient air temperature.

Through evaporative cooling, the evaporative cooling system 100 is capable of cooling liquids contained within the container 112 to a temperature that is about the same as, or slightly above, the “wet-bulb” temperature of the surrounding air. As used herein, the “wet-bulb” temperature is defined as the temperature at which the rate of energy transferred to the pouches 110, 210 by air that contacts the pouches 110, 210 equals the rate of energy loss caused by the water evaporating from the pouches 110, 210. Energy from liquid held within the container 112 is transferred to water held by the pouches 110, 210 by conductive cooling. Energy that is transferred to the water held within the pouches 110, 210 is then transferred to the surrounding air via evaporative cooling that results upon evaporation of water from the pouches 110, 2102. Of course, no evaporative cooling will occur unless the temperature of the water that is held within the pouches 110, 210 is greater than the wet-bulb temperature of the air that contacts the pouches 110, 210. The temperature of the water held within the pouches 110, 210 will generally depend on both the initial temperature of the water that is held within the pouch 110, 210 and the initial temperature of the liquid that is held within the container 112.

If the temperature of the liquid within the container 112 is initially below the wet-bulb temperature of the air surrounding the system 100, evaporative cooling by the cooling system 100 will typically not occur until the temperature of the liquid within the container 112 increases to a temperature that is greater than the wet-bulb temperature of the air surrounding the system 100. Those skilled in the art will understand that the wet-bulb temperature of the air that surrounds the cooling system 100 depends upon both the dry-bulb temperature of the air that surrounds the cooling system 100 and the relative humidity of the air that surrounds the cooling system 100.

As used herein, the term “dry-bulb temperature” means the temperature that is measured with a standard thermometer, where the standard thermometer includes a bulb that contains expansible fluid and where the bulb is free of liquid. The dry-bulb temperature is typically the ambient air temperature. As used herein, the term “relative humidity” is a measure, at a particular dry-bulb temperature, of how much additional water vapor the air, at the particular dry-bulb temperature, is capable of holding. If the air is saturated with water and incapable of holding additional water, then the air is said to have 100% relative humidity. The amount of moisture that air is capable of holding generally increases as the dry-bulb temperature of the air increases. As the relative humidity increases, the difference between the dry-bulb temperature and the wet-bulb temperature decreases. Thus at 100% relative humidity, the dry-bulb temperature of the air and the wet-bulb temperature of the air are essentially equal.

As an example, air having a dry-bulb temperature of about 85° F. and a relative humidity of 10% has a wet-bulb temperature of approximately 55° F., or a difference of a dry/wet-bulb temperature of about 30° F. As another example, air having a dry-bulb temperature of about 85° F., and a relative humidity of 20% has a wet-bulb temperature of approximately 60° F., or a difference of a dry/wet-bulb temperature of about 25° F. Those skilled in the art will understand that wet-bulb temperatures may be determined for various dry-bulb temperatures and relative humidities using a psychrometric chart.

In addition to the noted evaporative cooling effects, the cooling system 100 may be also used to chill the liquid within the container 112 by first filling the face fabric layer(s) 12 of the pouches 110, 210 with water having a temperature lower than the temperature of the liquid held within the container 112. Thermal energy of the liquid within the container 112 transfers to the cooler water held within the layer(s) 12 of the pouches 110, 210, thus exerting a conductive cooling effect upon the liquid held with the container 112.

Finally, it is noted than the evaporative cooling system 100 that includes either the pouch 110 or the pouch 210 may permissibly include, but does not require, the backing fabric layer 14. Preferably, the pouch 110 and the pouch 210 do not include the backing fabric layer 14, since the evaporative cooling control effect of the backing fabric layer 14 is typically not of any, or at least of any significant interest when cooling inanimate objects such as liquid held within the container 112. For this reason, including the backing fabric layer 14 in the pouches 110, 210 would undesirably increase the cost of producing, and manufacturing steps required to produce, the pouches 110, 210, without yielding any significant benefit to users of the cooling system 100. Thus, the purpose of the cooling system 100 (i.e.: cooling inanimate objects) dispenses with the need of the evaporative cooling control effect of the backing fabric layer 14, while the purpose of the evaporative cooling fabric 10 (i.e.: cooling mammals, for example) makes the evaporative cooling control effect of the backing fabric layer 14 an important benefit of the evaporative cooling fabric 10.

The present invention is more particularly described in the following examples that are intended as illustrations only, since numerous modifications and variations within the scope of the present invention will be apparent to those skilled in the art.

### EXAMPLES

### Example I

A sample of non-woven viscose rayon fabric that was dyed black and was produced as the face fabric layer 12 using a needle punch fabric formation technique was obtained from American Felt and Filter Corporation of Newburg, N.Y. The viscose rayon non-woven fabric was formed of viscose rayon fibers ranging from about 1.5 denier to about 4.0 denier. A layer of black nylon ripstop with an air permeability of about 40 cubic feet per minute (about 1.1 cubic meters per minute) that weighed about 1.08 ounces per square yard (about 36.6 grams per square meter), had a thickness of about 0.8 millimeters, and was formed of 30 denier nylon fibers was obtained for use as the backing fabric layer 14. The black nylon ripstock was obtained as SportShoot parachute material from Brookwood Laminating, Inc. of Peace Dale, R.I.

An ether-based, open cell polyurethane foam with a weight of about 1.5 pounds per cubic foot (about 24 kilograms per cubic meter) and a thickness of about 1 millimeter was selected for use as the adhesive layer 16. The non-woven viscose rayon fabric and the nylon ripstop were bonded to the polyurethane foam adhesive layer by heating both sides of the polyurethane foam adhesive layer using an open flame and thereafter sandwiching the heated polyurethane adhesive foam layer between the non-woven viscose rayon fabric and the nylon ripstop. The polyurethane foam that was used as the adhesive layer 30 was hydrophillic.

After attachment, it was determined that the bond strength between the layers 12, 16, 14 was strong and adequate to hold the viscose rayon fabric and the nylon ripstop fabric together and in registration with each other. The lamination affected by the polyurethane foam adhesive layer was quite effective, as demonstrated by the fact that raw cut edges of the laminate did not come apart during cutting, sewing, or packaging operations.

An evaporative cooling article in the form of a bandana with a hook and loop closure was formed from the evaporative cooling fabric made in this example. The bandana weighed 45 grams±5 grams when dry, and, after being soaked in water and allowed to drain, weighed 515±15 grams when wet. The water that had been absorbed in the viscose rayon fabric of the bandana was wrung out and the bandana, as wrung out, weighed about 95 grams. Samples of the bandana of this example were provided to bicycle riders. These bicycle riders reported about 3 hours of comfortable use was obtained using the bandanas, which had been saturated with fresh water, as a neck wrap before replenishment of the water in the viscose rayon fabric layer was required. Also, the riders reported that the bandanas provided a comfortable amount of cooling that helped minimize exertion on the part of the riders during the bicycle ride.

### Comparative Example I

A sample of non-woven, viscose rayon fabric formed by needlepunch with a weight of about 220 grams per square meter was obtained. The non-woven viscose rayon fabric was hot calendared to provide an exposed surface of this fabric with a softer hand. The hot calendared, non-woven viscose rayon fabric was formed into a clothing article for testing purposes. A hook and loop fastener was provided on opposing ends of the article. The clothing article had a dry weight of about 31±1 grams. After soaking the clothing article in a pail of water and allowing excess water to drain off, the clothing article was found to weigh about 800±20 grams. When wrung out by hand, the clothing article was found to have a weight of about 140±10 grams.

Clothing articles prepared in accordance with this comparative example, after wetting, were found to provide an intensive rate of cooling to the body of the user, though this cooling effect generally only lasted on the order of about 2 hours or less. It is believed that the lack of a covering fabric over the non-woven viscose rayon fabric prevented any real control over either the rate of evaporation or cooling from the evaporative cooling fabric produced in accordance with this comparative example. Thus, it was determined that the an insufficient cooling period at a poorly controlled intensity occurred when an evaporative cooling article was formed in accordance with this comparative example using viscose rayon only.

### Comparative Example II

The viscose rayon material used in Example I was used in this comparative example. A sheet of TYVEK® 1443 R spun bound polyolefin was used as a backing layer in this comparative example. TYVEK® 1443 R spun bound polyolefin may be obtained from E.I. duPont de Nemours and Co. of Wilmington, Del. The TYVEK® 1443 R spun bound polyolefin had a weight of about 0.5 ounces per square yard. A one millimeter thick layer of hot melt polyurethane sheet adhesive was positioned between, and laminated, to the viscose rayon fabric layer and the TYVEK® polyolefin layer using a George Knight No. 374 industrial heat press. The evaporative cooling fabric produced by this lamination had a hard and “board”-like feel when dry. After wetting, the test sample became more pliable and comfortable to wear, but the edges of the article remained stiff and uncomfortable and caused chaffing against the neck and face of the user.

Furthermore, despite the semi-porous nature of the TYVEK® polyolefin layer, the overall laminate was too effective at blocking evaporation. The evaporative cooling effect was normal around the perimeter of the fabric produced in accordance with this comparative example, but the interior of the fabric remained wet and actually accumulated heat during positioning against the user's body during an exerting activity. It is believed that the full coverage of the hot melt polyurethane sheet adhesive, in continuous fashion between the viscose rayon fabric and the TYVEK® polyolefin, despite the semi-porous nature of the TYVEK® polyolefin, prevented air from passing through the TYVEK® layer to the viscose rayon fabric layer. Consequently, little if any water was evaporated from the viscose rayon fabric layer, and the fabric provided little, if any, cooling effect to the user.

Although the present invention has been described with reference to preferred embodiments, workers skilled in the art will recognize that changes may be made in form and detail without departing from the spirit and scope of the invention.

1. An evaporative cooling article, the evaporative cooling article comprising a non-woven fabric, the non-woven fabric being water absorbent and exposed to atmosphere, the evaporative cooling article effective for exerting an evaporative cooling effect on a liquid held within a container when the container is in contact with the evaporative cooling article.

2. The evaporative cooling article of claim 1 wherein the evaporative cooling article is an evaporative cooling pouch, wherein the evaporative cooling pouch is effective for at least partially enclosing the container.

3. The evaporative cooling article of claim 2 wherein the evaporative cooling pouch comprises an elastic layer effective to hold the evaporative cooling pouch in contact with the container.

4. The evaporative cooling article of claim 1 wherein the non-woven fabric is adapted to hold water in an amount that is at least about eight times the dry weight of the non-woven fabric, as determined by ASTM Standard No. D4250/92.

5. The evaporative cooling article of claim 1 wherein the non-woven fabric has a sorption capacity of at least about 20 grams of liquid water per gram of dry weight of the non-woven fabric, as determined by ASTM Standard No. D5802/95.

6. The evaporative cooling article of claim 1 wherein the non-woven fabric comprises hydrophilic, polymeric fibers.

7. The evaporative cooling article of claim 1 wherein the non-woven fabric comprises polymeric fibers, the polymeric fibers being cellulose based.

8. The evaporative cooling article of claim 7 wherein the polymeric fibers of the non-woven fabric are formed of viscose rayon.

9. A method of using the evaporative cooling article of claim 1, the method comprising:
positioning the evaporative cooling article against the container with the evaporative cooling article exposed to a current of air;
placing water in the non-woven layer; and
allowing the current of air to pass through the evaporative cooling article and evaporate water from the evaporative cooling article, the evaporation of water producing a cooling effect on the liquid held within the container.

10. An evaporative cooling system, the evaporative cooling system comprising:
a container adapted for holding a liquid; and
a pouch, the pouch at least partially enveloping the container, the pouch comprising a non-woven fabric, the non-woven fabric being water absorbent and exposed to atmosphere, wherein the evaporative cooling system is effective for exerting a cooling effect on a liquid held within the container.

11. The evaporative cooling system of claim 10 wherein the non-woven fabric is adapted to hold water in an amount that is at least about eight times the dry weight of the non-woven fabric, as determined by ASTM Standard No. D4250/92.

12. The evaporative cooling system of claim 10 wherein the non-woven fabric has a sorption capacity of at least about 20 grams of liquid water per gram of dry weight of the non-woven fabric, as determined by ASTM Standard No. D5802/95.

13. The evaporative cooling system of claim 10 wherein the non-woven fabric comprises hydrophilic, polymeric fibers.

14. The evaporative cooling system of claim 10 wherein the non-woven fabric has a weight ranging from about 4 ounces per square yard to about 12 ounces per square yard.

15. The evaporative cooling system of claim 10 wherein the non-woven fabric comprises polymeric fibers, the polymeric fibers being cellulose based.

16. The evaporative cooling system of claim 15 wherein the polymeric fibers of the non-woven fabric are formed of viscose rayon.

17. An evaporative cooling article, the evaporative cooling article comprising:
a layer of elastic material; and
a non-woven fabric, the elastic material layer in working relation with the non-woven fabric, the non-woven fabric being water absorbent and exposed to atmosphere, the evaporative cooling article effective for exerting an evaporative cooling effect on a liquid held within a container when the evaporative cooling article is in contact with the evaporative cooling article.

18. The evaporative cooling article of claim 17 wherein the non-woven fabric is adapted to hold water in an amount that is at least about eight times the dry weight of the non-woven fabric, as determined by ASTM Standard No. D4250/92.

19. The evaporative cooling article of claim 17 wherein the non-woven fabric has a sorption capacity of at least about 20 grams of liquid water per gram of dry weight of the non-woven fabric, as determined by ASTM Standard No. D5802/95.

20. The evaporative cooling article of claim 17 wherein the non-woven fabric comprises polymeric fibers, the polymeric fibers comprising viscose rayon.

21. A method of making an evaporative cooling article, the method comprising:
incorporating a non-woven fabric in an material article, the non-woven fabric being water absorbent;
shaping the material to leave the non-woven fabric exposed to atmosphere and form the evaporative cooling the evaporative cooling article effective for exerting an evaporative cooling effect on a liquid held within a container when the container is in contact with the evaporative cooling article.

22. A method of making an evaporative cooling system, the method comprising:
forming a pouch, the pouch comprising a non-woven fabric, the non-woven fabric being water absorbent and exposed to atmosphere; and
placing a container within the pouch, the container adapted for holding a liquid, the pouch at least partially enclosing the container, and the evaporative cooling system effective for exerting a cooling effect on a liquid when the liquid is held within the container.

23. The method of claim 22, the method further comprising:
incorporating a layer of elastic material in working relation with the non-woven fabric.
